(19) United States
(12) Patent Application Publication
(10) Pub. No.: US 2017/0111266 A1
(43) Pub. Date: Apr. 20, 2017

(54) APPARATUSES AND METHODS FOR PROPAGATING DATA PACKETS IN A WIRELESS MESH NETWORK

(71) Applicant: MediaTek Inc., Hsin-Chu (TW)

(72) Inventor: Li-Chun KO, Taipei City (TW)

(21) Appl. No.: 15/296,201

(22) Filed: Oct. 18, 2016

Related U.S. Application Data
(60) Provisional application No. 62/243,210, filed on Oct. 19, 2015.

(51) Int. Cl. H04L 12/721; H04W 8/22; H04W 40/26; H04L 12/823; H04L 12/741; H04L 12/751

(52) U.S. Cl. CPC H04L 45/32; H04L 45/74; H04L 45/02; H04W 40/26; H04L 47/32; H04L 45/06; H04W 8/22; H04W 84/18

(57) ABSTRACT

A wireless communication device serving as an edge node is provided. The wireless communication device includes a wireless transceiver and a controller. The wireless transceiver performs wireless transmission and reception in a wireless mesh network. The controller determines whether the wireless communication device supports a routing-based propagation mechanism and a flooding-based propagation mechanism in response to originating a transmission of a data packet towards a destination in the wireless mesh network, determines whether a valid route exists towards the destination when the wireless communication device supports the routing-based propagation mechanism and the flooding-based propagation mechanism, and when the valid route exists, sets a routing indication in a packet header of the data packet and uses the routing-based propagation mechanism to transmit the data packet via the wireless transceiver.

### CROSS REFERENCE TO RELATED APPLICATIONS

This Application claims priority of U.S. Provisional Application No. 62/243,210, filed on Oct. 19, 2015, the entirety of which is incorporated by reference herein.

### BACKGROUND OF THE APPLICATION

Field of the Application

The application relates generally to the wireless communications, and more particularly, to apparatuses and methods for propagating data packets in a wireless mesh network including both Mesh Routing-enabled nodes and nodes that support only flooding.

Description of the Related Art

The use of wireless mesh networks has increased in recent years to improve the range of wireless communications. A wireless mesh network typically includes a plurality of wireless nodes that communicate with one another to propagate data packets. For example, in a multi-hop wireless mesh network, a data packet is propagated from a source node, or an originating node, to a destination node by “hopping” from one wireless node to another until the data packet reaches the destination node. As such, each node in a wireless mesh network operates as both a receiver and a transmitter to communicate data packets between intermediate nodes.

Flooding is a common network operation in which a data packet is sent by one node to every other node in a wireless mesh network. Each wireless node that receives that data packet, and hasn't received it before, forwards it to every other known neighboring node except for the originating node. The flooding of data packets can be performed in either unicast or broadcast transmissions. Unicast transmissions are point to point, one node to another, with an acknowledgment packet sent back as a reply. Unicast transmissions are a reliable means of communication, but they can be problematic in very dense networks because the number of unicast packets needed to perform the flooding operation increases quadratically with the number of nodes in a wireless mesh network. Broadcast transmissions are point to multipoint, one node to every other node within the range of wireless communications. In a broadcast transmission, the number of data packets necessary to flood increases linearly with the number of nodes. In this regard, flooding with broadcast transmissions is more efficient than flooding with unicast transmissions. However, broadcast transmissions do not acknowledge receipt of data packets, so they are considered less reliable than unicast transmissions.

### BRIEF SUMMARY OF THE APPLICATION

In a first aspect of the application, a wireless communication device serving as an edge node is provided. The wireless communication device comprises a wireless transceiver and a controller. The wireless transceiver is configured to perform wireless transmission and reception in a wireless mesh network. The controller is configured to determine whether the wireless communication device supports a routing-based propagation mechanism and a flooding-based propagation mechanism in response to originating a transmission of a data packet towards a destination in the wireless mesh network, determine whether a valid route exists towards the destination when the wireless communication device supports the routing-based propagation mechanism and the flooding-based propagation mechanism, and when the valid route exists, set a routing indication in a packet header of the data packet and use the routing-based propagation mechanism to transmit the data packet via the wireless transceiver.

In a second aspect of the application, a method for a wireless communication device serving as an edge node to propagate a data packet in a wireless mesh network is provided. The method comprises the steps of: determining whether the wireless communication device supports a routing-based propagation mechanism and a flooding-based propagation mechanism in response to originating a transmission of the data packet towards a destination in the wireless mesh network; determining whether a valid route exists towards the destination when the wireless communication device supports the routing-based propagation mechanism and the flooding-based propagation mechanism; and setting a routing indication in a packet header of the data packet and using the routing-based propagation mechanism to transmit the data packet, when the valid route exists.

In a third aspect of the application, a wireless communication device serving as a relay node is provided. The wireless communication device comprises a wireless transceiver and a controller. The wireless transceiver is configured to perform wireless transmission and reception in a wireless mesh network. The controller is configured to determine whether a routing indication in a packet header of a data packet is set and whether the wireless communication device supports a routing-based propagation mechanism and a flooding-based propagation mechanism in response to receiving the data packet from another wireless communication device in the wireless mesh network, and use the routing-based propagation mechanism or the flooding-based propagation mechanism to forward the data packet in the wireless mesh network via the wireless transceiver according to the determination results.

In a fourth aspect of the application, a method for a wireless communication device serving as a relay node to propagate a data packet in a wireless mesh network is provided. The method comprises the steps of: determining whether a routing indication in a packet header of the data packet is set and whether the wireless communication device supports a routing-based propagation mechanism and a flooding-based propagation mechanism in response to receiving the data packet from another wireless communication device in the wireless mesh network; and using the routing-based propagation mechanism or the flooding-based propagation mechanism to forward the data packet in the wireless mesh network according to the determination results.

Other aspects and features of the application will become apparent to those with ordinary skill in the art upon review of the following descriptions of specific embodiments of the wireless communication devices and methods for propagating a data packet in a wireless mesh network.

### BRIEF DESCRIPTION OF THE DRAWINGS

The application can be more fully understood by reading the subsequent detailed description and examples with references made to the accompanying drawings, wherein:

FIG. 1 is a block diagram illustrating a wireless communication device according to an embodiment of the application;

FIG. 2 is a flow chart illustrating the method for a wireless communication device serving as an edge node to propagate a data packet in a wireless mesh network according to an embodiment of the application;

FIG. 3 is a flow chart illustrating the method for a wireless communication device serving as a relay node to propagate a data packet in a wireless mesh network according to an embodiment of the application;

FIG. 4 is a block diagram illustrating delivery of a data packet in a wireless mesh network using the routing-based propagation mechanism according to an embodiment of the application; and

FIG. 5 is a block diagram illustrating delivery of a data packet in a wireless mesh network using the flooding-based propagation mechanism according to an embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The Bluetooth specifications are used to teach the spirit of the application, and the application is not limited thereto.

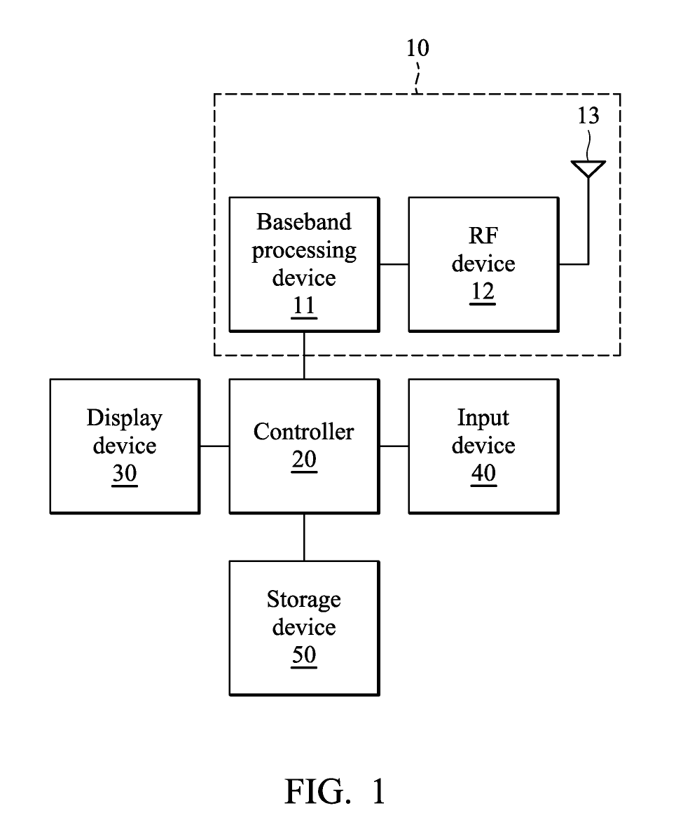

FIG. 1 is a block diagram illustrating a wireless communication device according to an embodiment of the application. The wireless communication device includes a wireless transceiver 10, a controller 20, a display device 30, an input device 40, and a storage device 50. For example, the wireless communication device may be a mobile phone, panel Personal Computer (PC), notebook, smart TV, gaming console, or any computing device which supports wireless communications, such as Bluetooth communications.

The wireless transceiver 10 includes a baseband processing device 11, a Radio Frequency (RF) device 12, and an antenna 13. The baseband processing device 11 may contain multiple hardware components to perform baseband signal processing, including Analog-to-Digital Conversion (ADC)/Digital-to-Analog Conversion (DAC), gain adjusting, modulation/demodulation, encoding/decoding, and so on. The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware components to perform radio frequency conversion. For example, the RF device 12 may comprise a mixer to multiply the baseband signals with a carrier oscillated in the radio frequency of the supported wireless technologies, wherein the radio frequency may be 2.4 to 2.485 GHz utilized in the Bluetooth technology, or 2.4 GHz, 3.6 GHz, 4.9 GHz, or 5 GHz utilized in the WiFi technology, or another radio frequency, depending on the wireless technology in use.

The controller 20 may be a general-purpose processor, Micro-Control Unit (MCU), Digital Signal Processor (DSP), application processor, or the like, which includes various circuitry for providing the function of data processing and computing, controlling the wireless transceiver 10 for wireless communications, sending a series of frame data (e.g. representing text messages, graphics, images, etc.) to the display device 30, receiving signals from the input device 40, or storing and retrieving data to and from the storage device 50. In particular, the controller 20 coordinates the aforementioned operations of the wireless transceiver 10, the display device 30, the input device 40, and the storage device 50 for performing the method of the present application. In another embodiment, the controller 20 can be software or firmware or program commands that can be executed by a general-purpose processor, Micro-Control Unit (MCU), Digital Signal Processor (DSP), application processor, or the like, to perform the aforementioned operations of the wireless transceiver 10, the display device 30, the input device 40, and the storage device 50 for performing the method of the present application.

As will be appreciated by persons skilled in the art, the circuitry will typically comprise transistors that are configured in such a way as to control the operation of the circuitry in accordance with the functions and operations described herein. As will be further appreciated, the specific structure or interconnections of the transistors will typically be determined by a compiler, such as a register transfer language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

In another embodiment, the controller 20 may be incorporated into the wireless transceiver 10, serving as a baseband processor.

The display device 30 may be a Liquid-Crystal Display (LCD), Light-Emitting Diode (LED) display, or Electronic Paper Display (EPD), etc., for providing a display function. Alternatively, the display device 30 may further include one or more touch sensors disposed thereon or thereunder for sensing touches, contacts, or approximations of objects, such as fingers or styluses.

The input device 40 may include one or more buttons, a keyboard, a mouse, a touch pad, a video camera, a microphone, and/or a speaker, etc., serving as the Man-Machine Interface (MIMI) for interaction with users.

The storage device 50 is a non-transitory machine-readable storage medium, including a memory, such as a FLASH memory or a Non-volatile Random Access Memory (NVRAM), or a magnetic storage device, such as a hard disk or a magnetic tape, or an optical disc, or any combination thereof for storing instructions or program code of communication protocol or applications.

It should be understood that the components described in the embodiment of FIG. 1 are for illustrative purposes only and are not intended to limit the scope of the application. For example, the wireless communication device may include more components to support other wireless technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and LTE-Advanced (LTE-A) technology, etc.

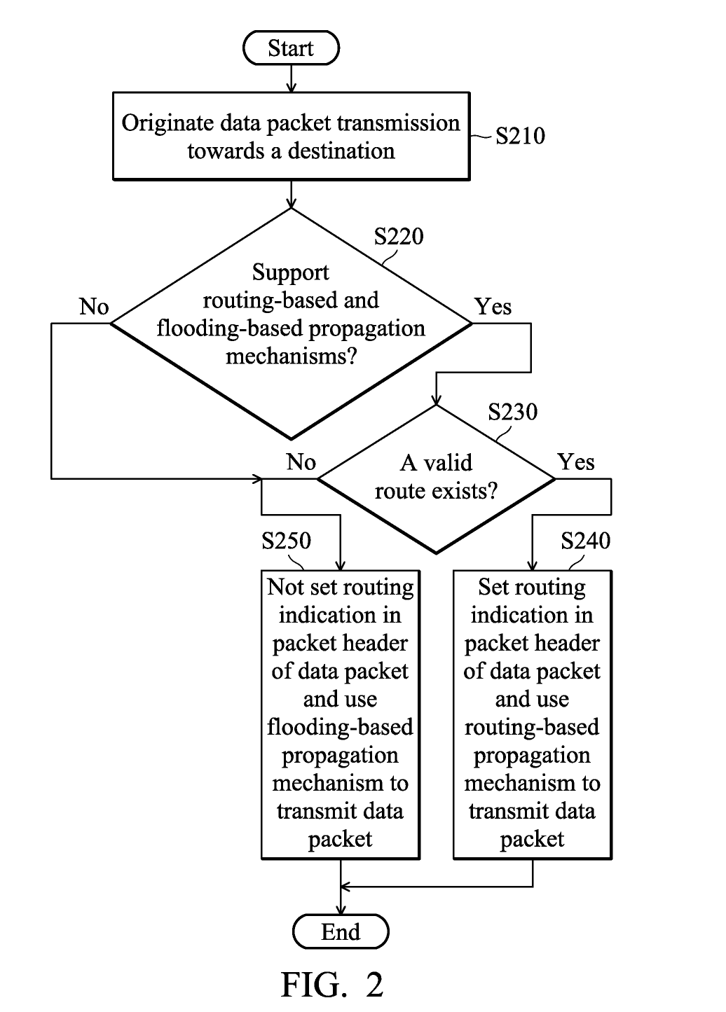

FIG. 2 is a flow chart illustrating the method for a wireless communication device serving as an edge node to propagate a data packet in a wireless mesh network according to an embodiment of the application. To begin, the wireless communication device originates transmission of a data packet towards a destination in the wireless mesh network (step S210). In response to originating transmission of the data packet, the wireless communication device determines whether it supports a routing-based propagation mechanism and a flooding-based propagation mechanism (step S220).

With the routing-based propagation mechanism, a data packet is propagated along a path/route by hopping from one node to another until it reaches its destination, and there may be more than one path/route between the source and the destination in the wireless mesh network. With the flooding-based propagation mechanism, every incoming data packet is forwarded through every outgoing link except the one it arrived on.

If the wireless communication device supports both the routing-based propagation mechanism and the flooding-based propagation mechanism, it determines whether a valid route exists towards the destination (step S230). If a valid route exists, the wireless communication device sets the routing indication in the packet header of the data packet and uses the routing-based propagation mechanism to transmit the data packet (step S240), and the method ends.

The wireless communication device may have previously performed a route discovery procedure to find one or more valid paths/routes towards the destination and keep monitoring the status of the valid paths/routes. Please note that the detailed descriptions regarding route discovery and maintenance is omitted herein as it is beyond the scope of the application, and reference may be made to the Bluetooth Mesh Routing specifications v1.1.

In one embodiment, the routing indication may be a Routing Protocol (RP) flag which indicates use of the routing-based propagation mechanism when it is set to TRUE, and indicates use of the flooding-based propagation mechanism when it is not set (i.e., the initially set value is FALSE).

Subsequent to step S230, if no valid route exists, the wireless communication device does not set the routing indication in the packet header of the data packet and uses the flooding-based propagation mechanism to transmit the data packet (step S250), and the method ends.

Subsequent to step S220, if the wireless communication device supports only the flooding-based propagation mechanism, the method flow proceeds to step S250.

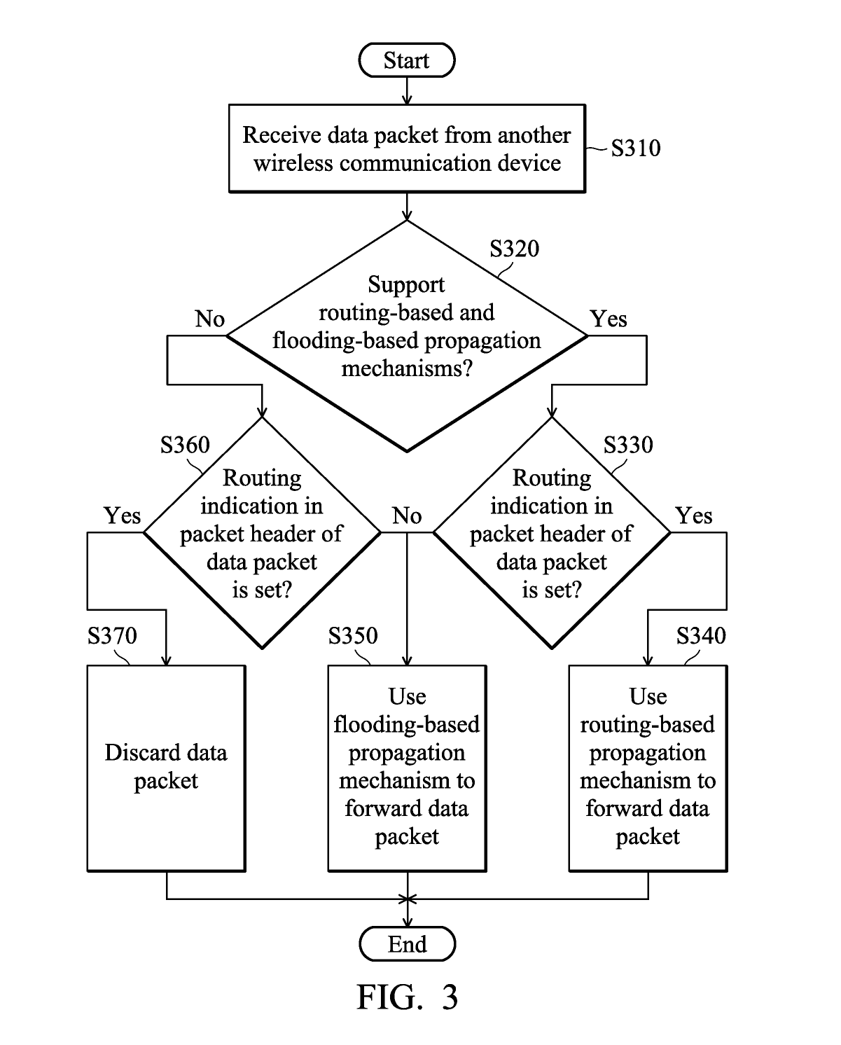

FIG. 3 is a flow chart illustrating the method for a wireless communication device serving as a relay node to propagate a data packet in a wireless mesh network according to an embodiment of the application. To begin, the wireless communication device receives a data packet from another wireless communication device in the wireless mesh network (step S310). In response to receiving the data packet, the wireless communication device determines whether the wireless communication device supports a routing-based propagation mechanism and a flooding-based propagation mechanism (step S320).

If the wireless communication device supports both the routing-based propagation mechanism and the flooding-based propagation mechanism, it determines whether the routing indication in the packet header of the data packet is set (step S330). If the routing indication is set, the wireless communication device uses the routing-based propagation mechanism to forward the data packet in the wireless mesh network (step S340), and the method ends. Otherwise, if the routing indication is not set, the wireless communication device uses the flooding-based propagation mechanism to forward the data packet in the wireless mesh network (step S350), and the method ends.

Subsequent to step S320, if the wireless communication device supports only the flooding-based propagation mechanism, it determines whether the routing indication in the packet header of the data packet is set (step S360). If the routing indication is set, the wireless communication device discards the data packet, i.e., it does not forward the data packet (step S370). Otherwise, if the routing indication is not set, the method flow proceeds to step S350.

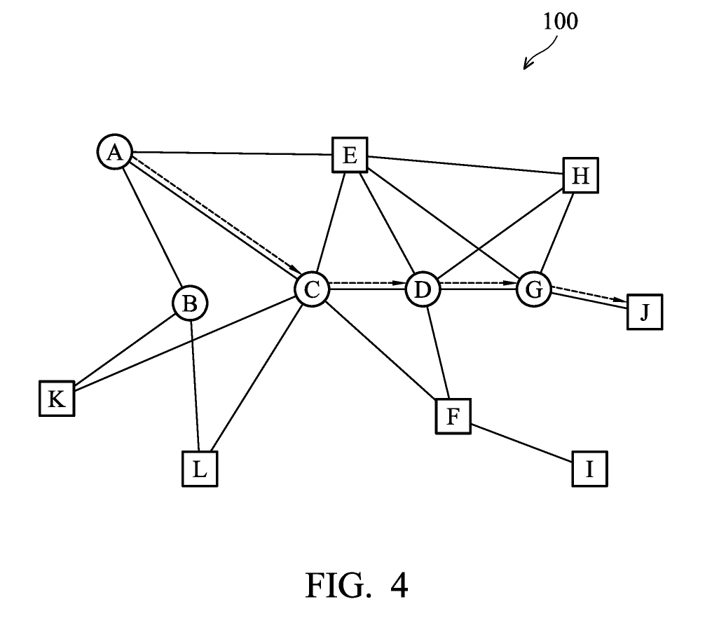

FIG. 4 is a block diagram illustrating delivery of a data packet in a wireless mesh network using the routing-based propagation mechanism according to an embodiment of the application. The wireless mesh network 100 includes a plurality of wireless communication devices A to L, wherein the wireless communication devices A, K, L, I, J, H are edge nodes which are unable to forward data packets and the wireless communication devices B, C, D, E, F, G are relay nodes which have the ability to forward data packets using a routing-based propagation mechanism and/or a flooding-based propagation mechanism. Specifically, the wireless communication devices that support forwarding data packets using both the routing-based propagation mechanism and the flooding-based propagation mechanism may be referred to as high-end relay nodes and they are depicted in circular figures, while the wireless communication devices that support forwarding data packets using only the flooding-based propagation mechanism may be referred to as normal relay nodes and they are depicted in square figures.

As shown in FIG. 4, the wireless communication device A originates transmission of a data packet to the wireless communication device J. In this embodiment, it is assumed that there is a valid route between the wireless communication devices A and J. Due to there being a valid route towards the destination and the wireless communication device A supporting both the routing-based propagation mechanism and the flooding-based propagation mechanism, the wireless communication device A sets the routing indication in the packet header of the data packet and uses the routing-based propagation mechanism to transmit the data packet.

According to the route information, the data packet is transmitted from the wireless communication device A to the wireless communication device C where it is then forwarded to the wireless communication device D. When receiving the data packet, the wireless communication device D forwards the data packet to the wireless communication device G where the data packet is finally forwarded to the wireless communication device J.

Please note that, along the route, all the relay nodes support both the routing-based propagation mechanism and the flooding-based propagation mechanism, and they choose to use the routing-based propagation mechanism to forward the data packet when determining that the routing indication in the packet header of the received data packet is set.

Alternatively, if there's no valid route between the wireless communication devices A and J, the wireless communication device A may not set the routing indication and use the flooding-based propagation mechanism instead to transmit the data packet.

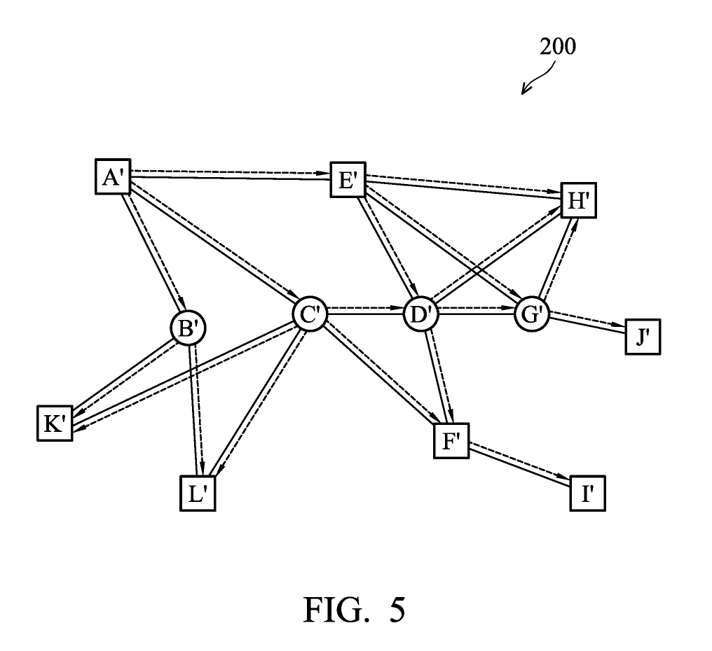

FIG. 5 is a block diagram illustrating delivery of a data packet in a wireless mesh network using the flooding-based propagation mechanism according to an embodiment of the application. The wireless mesh network 200 includes a plurality of wireless communication devices A′ to L′, wherein the wireless communication devices A, K, L, I, J, H are edge nodes which are unable to forward data packets and the wireless communication devices B, C, D, E, F, G are relay nodes which have the ability to forward data packets using a routing-based propagation mechanism and/or a flooding-based propagation mechanism. The network topology in FIG. 5 is similar to the network topology in FIG. 4, except that the wireless communication device A in FIG. 5 is depicted in a square figure, which means that it supports only the flooding-based propagation mechanism.

As shown in FIG. 5, when originating transmission of a data packet to the wireless communication device J, the wireless communication device A does not set the routing indication in the packet header of the data packet and uses the flooding-based propagation mechanism instead to transmit the data packet. With the flooding-based propagation mechanism, every relay node receiving the data packet simply forwards it through every outgoing link except the one it arrived on.

In view of the forgoing embodiments, it will be appreciated that the present application realizes an ideal integration of the routing-based propagation mechanism and the flooding-based propagation mechanism for data packet delivery in wireless mesh networks, by specifying a routing indication in the packet header of a data packet to be delivered. Therefore, the advantages of the routing-based propagation mechanism and the flooding-based propagation mechanism are provided for data packet delivery in wireless mesh network, wherein the flooding-based propagation mechanism may achieve lower deployment cost and better reachability while the routing-based propagation mechanism may achieve lower traffic overhead.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A wireless communication device, serving as an edge node, comprising:
a wireless transceiver configured to perform wireless transmission and reception in a wireless mesh network; and
a controller configured to determine whether the wireless communication device supports a routing-based propagation mechanism and a flooding-based propagation mechanism in response to originating a transmission of a data packet towards a destination in the wireless mesh network, determine whether a valid route exists towards the destination when the wireless communication device supports the routing-based propagation mechanism and the flooding-based propagation mechanism, and when the valid route exists, set a routing indication in a packet header of the data packet and use the routing-based propagation mechanism to transmit the data packet via the wireless transceiver.

2. The wireless communication device as claimed in claim 1, wherein the controller is further configured to not set the routing indication in the packet header of the data packet and use the flooding-based propagation mechanism to transmit the data packet via the wireless transceiver, when the valid route does not exist.

3. The wireless communication device as claimed in claim 1, wherein the controller is further configured to not set the routing indication in the packet header of the data packet and use the flooding-based propagation mechanism to transmit the data packet via the wireless transceiver, when the wireless communication device supports only the flooding-based propagation mechanism.

4. The wireless communication device as claimed in claim 1, wherein the wireless communication device is a Bluetooth Mesh Routing-enabled node.

5. A method for a wireless communication device serving as an edge node to propagate a data packet in a wireless mesh network, the method comprising:
determining whether the wireless communication device supports a routing-based propagation mechanism and a flooding-based propagation mechanism in response to originating a transmission of the data packet towards a destination in the wireless mesh network;
determining whether a valid route exists towards the destination when the wireless communication device supports the routing-based propagation mechanism and the flooding-based propagation mechanism; and
setting a routing indication in a packet header of the data packet and using the routing-based propagation mechanism to transmit the data packet, when the valid route exists.

6. The method as claimed in claim 5, further comprising:
not setting the routing indication in the packet header of the data packet and using the flooding-based propagation mechanism to transmit the data packet, when the valid route does not exist.

7. The method as claimed in claim 5, further comprising:
not setting the routing indication in the packet header of the data packet and using the flooding-based propagation mechanism to transmit the data packet, when the wireless communication device supports only the flooding-based propagation mechanism.

8. The method as claimed in claim 5, wherein the wireless communication device is a Bluetooth Mesh Routing-enabled node.

9. A wireless communication device, serving as a relay node, comprising:
a wireless transceiver configured to perform wireless transmission and reception in a wireless mesh network; and
a controller configured to determine whether a routing indication in a packet header of a data packet is set and whether the wireless communication device supports a routing-based propagation mechanism and a flooding-based propagation mechanism in response to receiving the data packet from another wireless communication device in the wireless mesh network, and use the routing-based propagation mechanism or the flooding-based propagation mechanism to forward the data packet in the wireless mesh network via the wireless transceiver according to the determination results.

10. The wireless communication device as claimed in claim 9, wherein the controller is further configured to use the routing-based propagation mechanism to forward the data packet in the wireless mesh network via the wireless transceiver when the routing indication is set and the wireless communication device supports the routing-based propagation mechanism and the flooding-based propagation mechanism.

11. The wireless communication device as claimed in claim 9, wherein the controller is further configured to use the flooding-based propagation mechanism to forward the data packet in the wireless mesh network via the wireless transceiver when the routing indication is not set.

12. The wireless communication device as claimed in claim 9, wherein the controller is further configured to discard the data packet when the routing indication is set and the wireless communication device supports only the flooding-based propagation mechanism.

13. A method for a wireless communication device serving as a relay node to propagate a data packet in a wireless mesh network, the method comprising:
determining whether a routing indication in a packet header of the data packet is set and whether the wireless communication device supports a routing-based propagation mechanism and a flooding-based propagation mechanism in response to receiving the data packet from another wireless communication device in the wireless mesh network; and
using the routing-based propagation mechanism or the flooding-based propagation mechanism to forward the data packet in the wireless mesh network according to the determination results.

14. The method as claimed in claim 13, further comprising:
using the routing-based propagation mechanism to forward the data packet in the wireless mesh network when the routing indication is set and the wireless communication device supports the routing-based propagation mechanism and the flooding-based propagation mechanism.

15. The method as claimed in claim 13, further comprising:
using the flooding-based propagation mechanism to forward the data packet in the wireless mesh network when the routing indication is not set

16. The method as claimed in claim 13, further comprising:
discarding the data packet when the routing indication is set and the wireless communication device supports only the flooding-based propagation mechanism.
